(19) United States
(12) Patent Application Publication
(10) Pub. No.: US 2017/0132027 A1
(43) Pub. Date: May 11, 2017

(54) SYSTEMS AND METHODS FOR COORDINATING DATA CACHING ON VIRTUAL STORAGE APPLIANCES

(71) Applicant: Symantec Corporation, Mountain View, CA (US)

(72) Inventors: Vaijayanti Bharadwaj, Pune (IN); Chirag Dalal, Pune (IN)

(21) Appl. No.: 14/935,836

(22) Filed: Nov. 9, 2015

(51) Int. Cl. G06F 9/455; H04L 29/08; G06F 12/08

(52) U.S. Cl. CPC G06F 9/45558; G06F 12/0862; H04L 67/2842; G06F 2212/152; G06F 2212/154; G06F 2212/6022; G06F 2009/45583; G06F 2009/45595

(57) ABSTRACT

A computer-implemented method for coordinating data caching on virtual storage appliances may include (1) receiving, at a first virtual storage appliance, a request for data from a virtual machine in a first set of virtual machines served by the first virtual storage appliance, (2) determining that the requested data is not cached at the first virtual storage appliance, (3) determining that a second virtual storage appliance is responsible for caching the requested data from a remote data source, (4) transferring the requested data from the second virtual storage appliance to the first virtual storage appliance, and (5) providing the requested data from the first virtual storage appliance to the virtual machine. Various other methods, systems, and computer-readable media are also disclosed.

### BACKGROUND

Cloud environments provide customized virtual computing environments for applications that require different hardware, firmware, and software setups. For example, in application development, different hardware and operating systems may be simulated for various test cases running on virtual machines within a cloud environment. Traditionally, in these environments, a virtual machine may request needed data from an on-premise appliance over a network connection. However, due to bandwidth issues when data is frequently requested by multiple virtual machines, there may be a high network latency that negatively affects the cloud environment.

Virtual storage appliances (VSAs) may sometimes be used to overcome high network latency and provide local copies of data. For example, a local, cloud-based VSA may cache the data required by a virtual machine so that the virtual machine does not need to request data from a remote on-premise appliance. However, when different virtual machines require different data, such as in testing different versions of software, a single VSA may be overloaded in trying to cache all of the required data. Furthermore, when multiple VSAs are used to serve multiple virtual machines, multiple similar copies of data in the VSAs cause an inefficient use of storage resources. Accordingly, the instant disclosure identifies and addresses a need for additional and improved systems and methods for handling data caching in copy data management.

### SUMMARY

As will be described in greater detail below, the instant disclosure generally relates to systems and methods for coordinating data caching on virtual storage appliances by using multiple virtual storage appliances, each serving a different group of virtual machines. The disclosed systems may group the virtual machines based on the data and environment requirements of the virtual machines. Additionally, as part of a copy data management system, this system may distribute the original data stored at a remote data source by assigning each virtual storage appliance with a segment of the data to be cached. Furthermore, the virtual storage appliances may then use peer-to-peer caching in order to coordinate transfer of data among themselves.

In one example, a computer-implemented method for coordinating data caching on virtual storage appliances may include (1) receiving, at a first virtual storage appliance, a request for data from a virtual machine in a first set of virtual machines served by the first virtual storage appliance, (2) determining that the requested data is not cached at the first virtual storage appliance, (3) determining that a second virtual storage appliance is responsible for caching the requested data from a remote data source, (4) transferring the requested data from the second virtual storage appliance to the first virtual storage appliance, and (5) providing the requested data from the first virtual storage appliance to the virtual machine.

In one embodiment, the first virtual storage appliance may include a cloud-based storage controller that manages a local data cache for a hypervisor running the first set of virtual machines in a cloud environment containing the second virtual storage appliance. In another embodiment, the first set of virtual machines may include a grouping of at least one virtual machine sharing a common dataset that differs, based on a predefined threshold, from a second dataset shared by a second set of virtual machines.

In some examples, determining that the second virtual storage appliance is responsible for caching the requested data may include using a hashing algorithm that coordinates peer-to-peer caching among the first and second virtual storage appliances and/or identifying a data fingerprint of the requested data. In these examples, the hashing algorithm may include a set of rules to distribute data for copy data management.

In one embodiment, transferring the requested data from the second virtual storage appliance to the first virtual storage appliance may include locating the requested data in the second virtual storage appliance. In this embodiment, locating the requested data in the second virtual storage appliance may include finding the requested data cached at the second virtual storage appliance, copying the requested data from the remote data source to the second virtual storage appliance, and/or caching the requested data at the second virtual storage appliance. Additionally or alternatively, transferring the requested data from the second virtual storage appliance to the first virtual storage appliance may include caching at least part of the requested data at the first virtual storage appliance. In a further embodiment, transferring the requested data from the second virtual storage appliance to the first virtual storage appliance may include removing the requested data from the second virtual storage appliance. In this embodiment, removing the requested data from the second virtual storage appliance may include determining, based on a cache algorithm, that caching the requested data at the second virtual storage appliance is more costly than caching the requested data at the first virtual storage appliance and/or may including remapping a hash table based on the determination.

In one example, a system for implementing the above-described method may include (1) a reception module, stored in memory, that receives, at a first virtual storage appliance, a request for data from a virtual machine in a first set of virtual machines served by the first virtual storage appliance, (2) a determination module, stored in memory, that determines that the requested data is not cached at the first virtual storage appliance, (3) a coordination module, stored in memory, that determines that a second virtual storage appliance is responsible for caching the requested data from a remote data source, (4) a transfer module, stored in memory, that transfers the requested data from the second virtual storage appliance to the first virtual storage appliance, and (5) a provision module, stored in memory, that provides the requested data from the first virtual storage appliance to the virtual machine. In addition, the system may include at least one processor that executes the reception module, the determination module, the coordination module, the transfer module, and the provision module.

In some embodiments, the above-described method may be encoded as computer-readable instructions on a non-transitory computer-readable medium. For example, a computer-readable medium may include one or more computer-executable instructions that, when executed by at least one processor of a computing device, may cause the computing device to (1) receive, at a first virtual storage appliance, a request for data from a virtual machine in a first set of virtual machines served by the first virtual storage appliance, (2) determine that the requested data is not cached at the first virtual storage appliance, (3) determine that a second virtual storage appliance is responsible for caching the requested data from a remote data source, (4) transfer the requested data from the second virtual storage appliance to the first virtual storage appliance, and (5) provide the requested data from the first virtual storage appliance to the virtual machine.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram of an exemplary system for coordinating data caching on virtual storage appliances.

FIG. 2 is a block diagram of an additional exemplary system for coordinating data caching on virtual storage appliances.

FIG. 3 is a flow diagram of an exemplary method for coordinating data caching on virtual storage appliances.

FIG. 4 is an illustration of an exemplary cloud environment for coordinating data caching between an exemplary remote data source and exemplary hypervisors.

FIG. 5 is a block diagram of an exemplary computing system capable of implementing one or more of the embodiments described and/or illustrated herein.

FIG. 6 is a block diagram of an exemplary computing network capable of implementing one or more of the embodiments described and/or illustrated herein.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The present disclosure is generally directed to systems and methods for coordinating data caching on virtual storage appliances. As will be explained in greater detail below, by distributing caching of data among multiple virtual storage appliances, the disclosed systems and methods may reduce redundancy in storing data and latency in retrieving data. For example, the disclosed systems and methods may allow a VSA to obtain infrequently used data from peer VSAs that have cached the data, rather than a remote data source. Moreover, by grouping virtual machines that commonly use similar data, the disclosed systems and methods may also reduce the amount of data cached on a single VSA serving one group of virtual machines, such as a set of virtual machines running on a hypervisor.

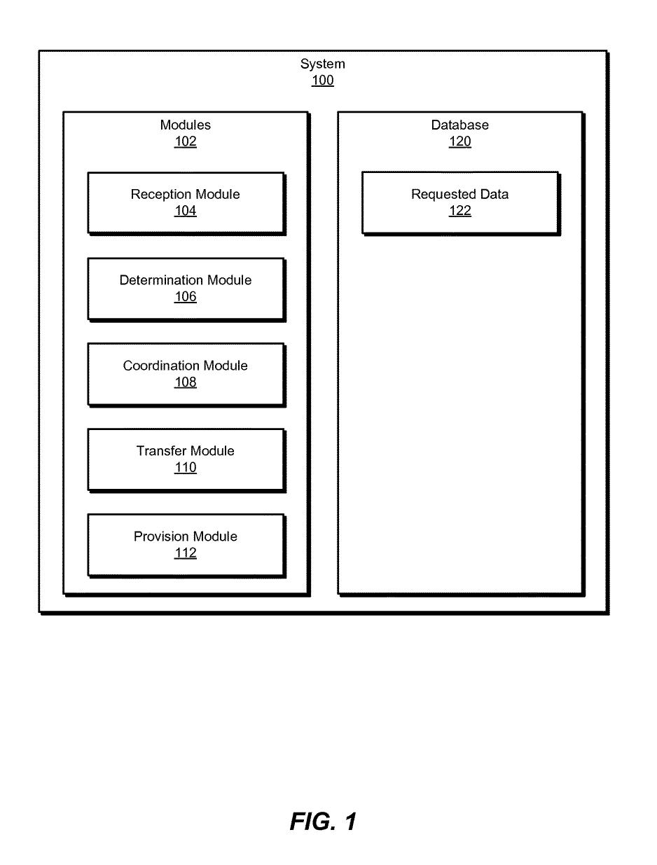

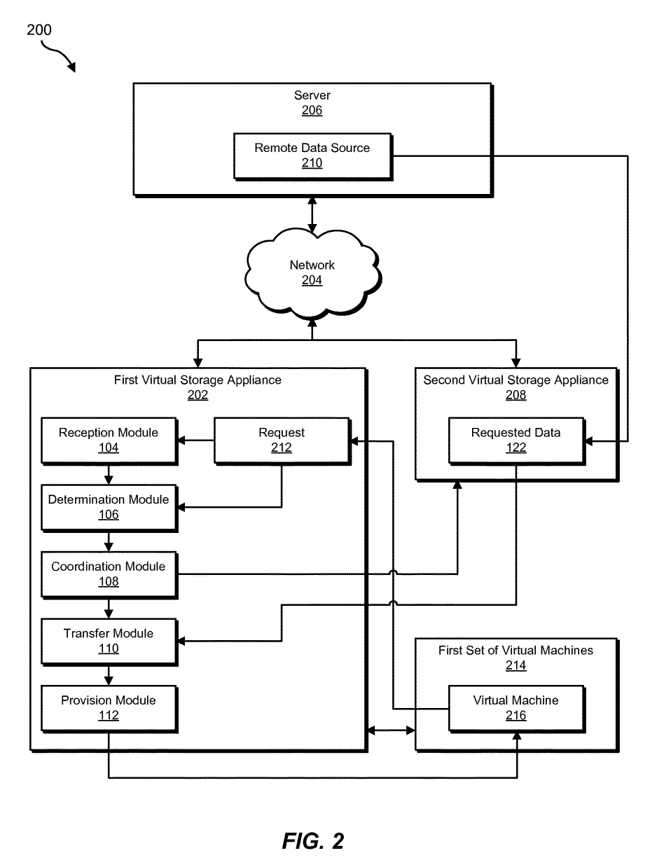

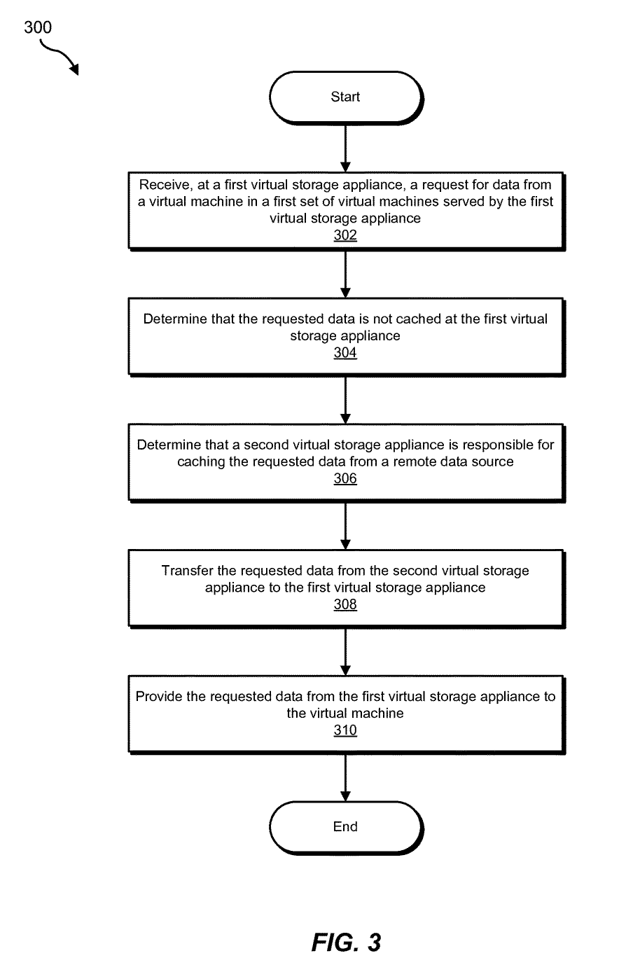

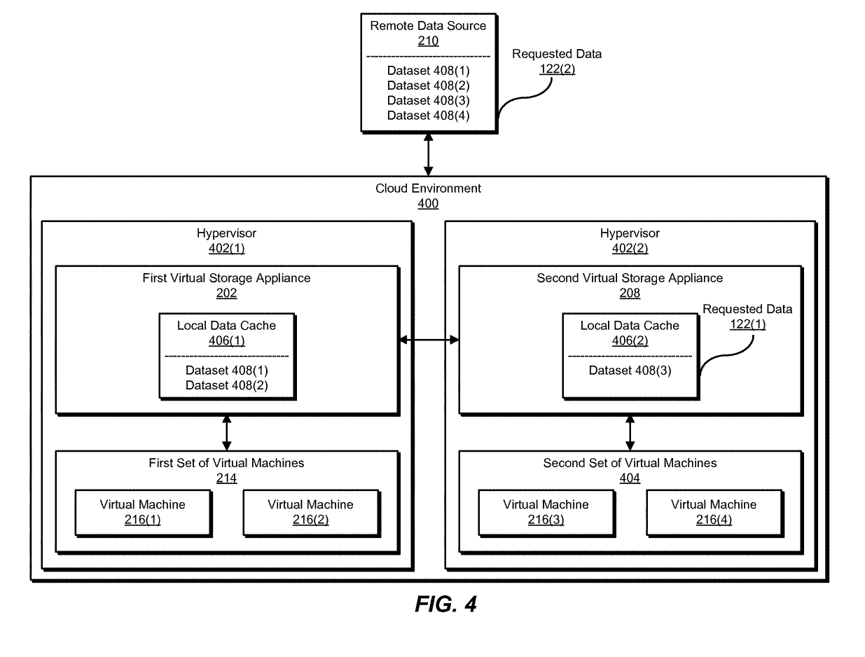

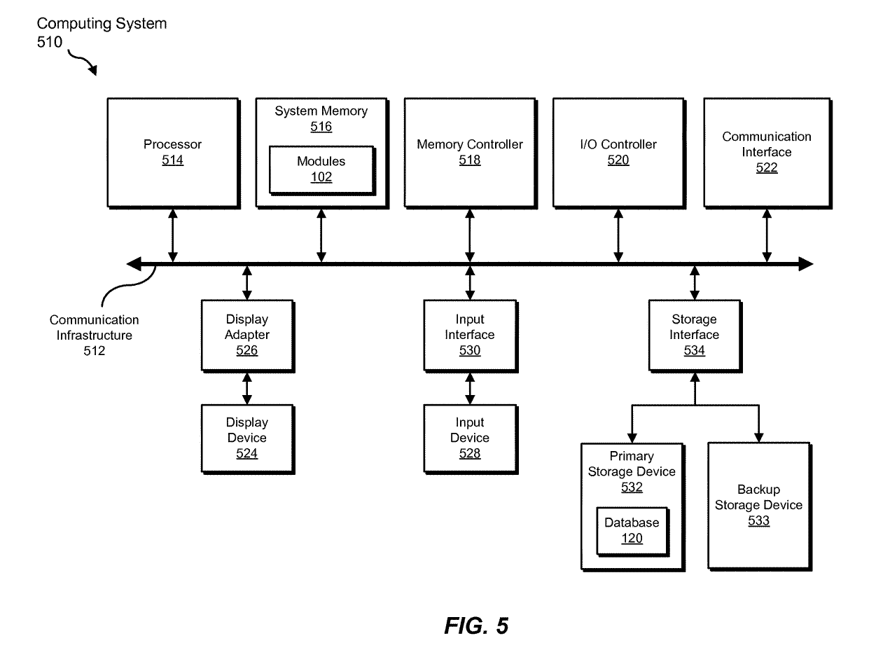

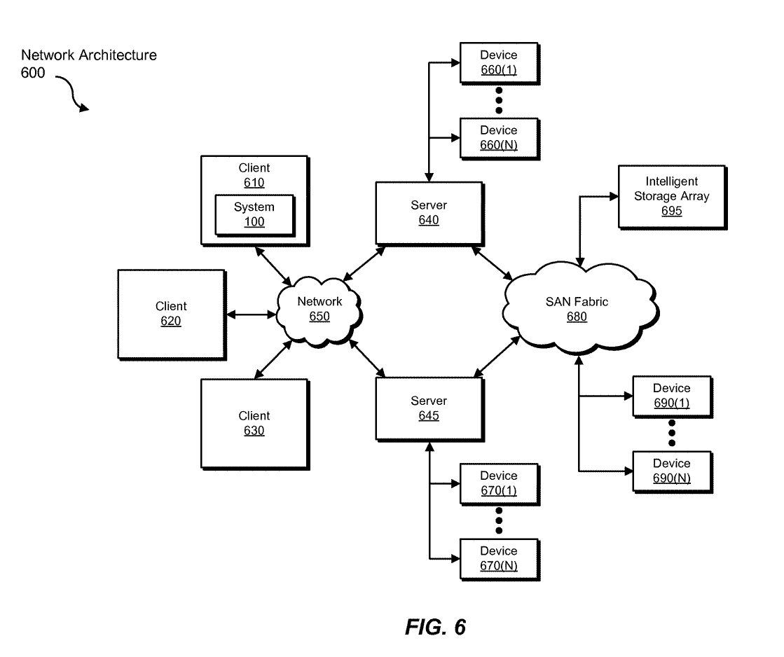

The following will provide, with reference to FIGS. 1 and 2, detailed descriptions of exemplary systems for coordinating data caching on virtual storage appliances. Detailed descriptions of corresponding computer-implemented methods will also be provided in connection with FIG. 3. In addition, detailed descriptions of an exemplary cloud environment for coordinating data caching between an exemplary remote data source and exemplary hypervisors will be provided in connection with FIG. 4. Furthermore, detailed descriptions of an exemplary computing system and network architecture capable of implementing one or more of the embodiments described herein will be provided in connection with FIGS. 5 and 6, respectively.

FIG. 1 is a block diagram of exemplary system 100 for coordinating data caching on virtual storage appliances. As illustrated in this figure, exemplary system 100 may include one or more modules 102 for performing one or more tasks. For example, and as will be explained in greater detail below, exemplary system 100 may also include a reception module 104 that may receive, at a first virtual storage appliance, a request for data from a virtual machine in a first set of virtual machines served by the first virtual storage appliance. As used herein, the term “virtual storage appliance,” or VSA, generally refers to a storage appliance used to manage a data cache for a virtual machine. Notably, a VSA may run as part of a virtual machine or as a separate virtual entity.

Exemplary system 100 may additionally include a determination module 106 that may determine that the requested data is not cached at the first virtual storage appliance. Exemplary system 100 may also include a coordination module 108 that may determine that a second virtual storage appliance is responsible for caching the requested data from a remote data source. The term “remote data source,” as used herein, generally refers to a data source outside of the cloud environment of the virtual storage appliances that is accessible through a network. Examples of remote data sources may include, without limitation, a data server, an on-premise storage appliance, a data warehouse appliance, memory in a computing device, virtual memory, or any other form of networked data storage.

Furthermore, exemplary system 100 may include a transfer module 110 that may transfer the requested data from the second virtual storage appliance to the first virtual storage appliance. Finally, exemplary system 100 may include a provision module 112 that may provide the requested data from the first virtual storage appliance to the virtual machine. Although illustrated as separate elements, one or more of modules 102 in FIG. 1 may represent portions of a single module or application.

In certain embodiments, one or more of modules 102 in FIG. 1 may represent one or more software applications or programs that, when executed by a computing device, may cause the computing device to perform one or more tasks. For example, and as will be described in greater detail below, one or more of modules 102 may represent software modules stored and configured to run on one or more computing devices, such as the devices illustrated in FIG. 2 (e.g., first virtual storage appliance 202, second virtual storage appliance 208, and/or server 206), computing system 510 in FIG. 5, and/or portions of exemplary network architecture 600 in FIG. 6. One or more of modules 102 in FIG. 1 may also represent all or portions of one or more special-purpose computers configured to perform one or more tasks.

As illustrated in FIG. 1, exemplary system 100 may also include one or more databases, such as database 120. In one example, database 120 may be configured to store requested data 122, which may include data required by a virtual machine. Additionally, database 120 may store other data required by different virtual machines.

Database 120 may represent portions of a single database or computing device or a plurality of databases or computing devices. For example, database 120 may represent a portion of server 206 in FIG. 2, computing system 510 in FIG. 5, and/or portions of exemplary network architecture 600 in FIG. 6. Alternatively, database 120 in FIG. 1 may represent one or more physically separate devices capable of being accessed by a computing device, such as server 206 in FIG. 2, computing system 510 in FIG. 5, and/or portions of exemplary network architecture 600 in FIG. 6.

Exemplary system 100 in FIG. 1 may be implemented in a variety of ways. For example, all or a portion of exemplary system 100 may represent portions of exemplary system 200 in FIG. 2. As shown in FIG. 2, system 200 may include a first virtual storage appliance 202 and a second virtual storage appliance 208 in communication with a server 206 via a network 204. In one example, first virtual storage appliance 202 may be programmed with one or more of modules 102 and/or may store all or a portion of the data in database 120. Additionally or alternatively, server 206 may be programmed with one or more of modules 102 and/or may store all or a portion of the data in database 120.

In one embodiment, one or more of modules 102 from FIG. 1 may, when executed by at least one processor of a computing device running first virtual storage appliance 202 and/or server 206, enable the computing device and/or server 206 to streamline data access and caching for virtual machines. For example, and as will be described in greater detail below, reception module 104 may receive, at first virtual storage appliance 202, a request 212 for data from a virtual machine 216 in a first set of virtual machines 214 served by first virtual storage appliance 202. Determination module 106 may determine that requested data 122 is not cached at first virtual storage appliance 202. Coordination module 108 may then determine that second virtual storage appliance 208 (which may be associated with a second set of virtual machines) is responsible for caching requested data 122 from a remote data source 210. Additionally, transfer module 110 may transfer requested data 122 from second virtual storage appliance 208 to first virtual storage appliance 202. Finally, provision module 112 may provide requested data 122 to virtual machine 216.

In the example of FIG. 2, and as will be explained in greater detail below, server 206 may include remote data source 210 that maintains data for a multitude of virtual machines. Data may be copied, via network 204, from remote data source 210 to networked VSAs. For example, as shown in FIG. 2, requested data 122 may be assigned to and cached at second virtual storage appliance 208. Virtual machine 216 may then send request 212 for requested data 122 to first virtual storage appliance 202, which is responsible for providing data to all virtual machines within first set of virtual machines 214. First virtual storage appliance 202 may determine requested data 122 is not in its own cache and subsequently determine that requested data 122 is assigned to second virtual storage appliance 208. Next, first virtual storage appliance 202 and second virtual storage appliance 208 may coordinate to transmit requested data 122 from second virtual storage appliance 208 to first virtual storage appliance 202. First virtual storage appliance 202 may then finally provide requested data 122 to virtual machine 216.

The computing device running first virtual storage appliance 202 generally represents any type or form of computing device capable of reading computer-executable instructions. Examples of the computing device include, without limitation, laptops, tablets, desktops, servers, combinations of one or more of the same, exemplary computing system 510 in FIG. 5, or any other suitable computing device. Additionally, the computing device may represent a server, such as server 206, or a virtual machine running on a physical server configured to run storage and/or database applications.

Server 206 generally represents any type or form of computing device that is capable of storing and/or managing data. Examples of server 206 include, without limitation, application servers, database servers, on-premise servers, data warehouses, file servers, Network-Attached Storage, or any other server configured to provide various database services and/or run certain software applications.

Network 204 generally represents any medium or architecture capable of facilitating communication or data transfer. Examples of network 204 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), exemplary network architecture 600 in FIG. 6, or the like. Network 204 may facilitate communication or data transfer using wireless or wired connections. In one embodiment, network 204 may facilitate communication between first virtual storage appliance 202 and/or second virtual storage appliance 208 and server 206.

FIG. 3 is a flow diagram of an exemplary computer-implemented method 300 for coordinating data caching on virtual storage appliances. The steps shown in FIG. 3 may be performed by any suitable computer-executable code and/or computing system. In some embodiments, the steps shown in FIG. 3 may be performed by one or more of the components of system 100 in FIG. 1, system 200 in FIG. 2, computing system 510 in FIG. 5, and/or portions of exemplary network architecture 600 in FIG. 6.

As illustrated in FIG. 3, at step 302, one or more of the systems described herein may receive, at a first virtual storage appliance, a request for data from a virtual machine in a first set of virtual machines served by the first virtual storage appliance. For example, reception module 104 may, as part of first virtual storage appliance 202 in FIG. 2, receive request 212 for data from virtual machine 216 in first set of virtual machines 214 served by first virtual storage appliance 202.

In one embodiment, first virtual storage appliance 202 may include a cloud-based storage controller that manages a local data cache for a hypervisor running first set of virtual machines 214 in a cloud environment containing second virtual storage appliance 208. The term “hypervisor,” as used herein, generally refers to software, firmware, and/or hardware that may run virtual machines and VSAs. Additionally, the term “cloud environment,” as used herein, generally refers to cloud-based computing resources that provide customized services for a specific purpose, such as application development.

In one example, as shown in FIG. 4, a cloud environment 400 may include a hypervisor 402(1) that runs first set of virtual machines 214, with a virtual machine 216(1) and a virtual machine 216(2), and a hypervisor 402(2) that runs a second set of virtual machines 404, with a virtual machine 216(3) and a virtual machine 216(4). First virtual storage appliance 202 may manage a local data cache 406(1) for hypervisor 402(1). Similarly, second virtual storage appliance 208 may manage a local data cache 406(2) for hypervisor 402(2). Additional hypervisors and VSAs may also run within cloud environment 400 to manage additional sets of virtual machines.

Reception module 104 may receive request 212 in a variety of ways. In the example of FIG. 4, first virtual storage appliance 202 may directly receive request 212 from a virtual machine running concurrently on hypervisor 402(1), such as virtual machine 216(1). In alternate examples, first virtual storage appliance 202 may run independently of hypervisor 402(1) and receive request 212 from virtual machine 216(1) via hypervisor 402(1).

In one embodiment, first set of virtual machines 214 may include a grouping of at least one virtual machine sharing a common dataset that differs, based on a predefined threshold, from a second dataset shared by a second set of virtual machines. In the example of FIG. 4, virtual machine 216(1) and virtual machine 216(2) may share a dataset 408(1) and a dataset 408(2) that differ from a dataset 408(3) shared by virtual machine 216(3) and virtual machine 216(4). The predefined threshold may vary based on the requirements of cloud environment 400. In some embodiments, the predefined threshold may indicate different versions of similar data. In the example of FIG. 4, datasets 408(1), 408(2), and 408(3) may represent different versions of test data used during an application development process that tests different environments in hypervisor 402(1) and hypervisor 402(2). In other embodiments, the predefined threshold may indicate different partitions of a dataset in remote data source 210.

Returning to FIG. 3, at step 304, one or more of the systems described herein may determine that the requested data is not cached at the first virtual storage appliance. For example, determination module 106 may, as part of first virtual storage appliance 202 in FIG. 2, determine that requested data 122 is not cached at first virtual storage appliance 202.

Determination module 106 may determine that requested data 122 is not cached at first virtual storage appliance 202 in a variety of ways. In the example of FIG. 4, first virtual storage appliance 202 may determine local data cache 406(1) does not contain requested data 122 and, therefore, may not provide requested data 122 to virtual machine 216(1). In other examples, determination module 106 may determine that first virtual storage appliance 202 is not responsible for caching requested data 122 from remote data source 210.

Returning to FIG. 3, at step 306, one or more of the systems described herein may determine that a second virtual storage appliance is responsible for caching the requested data from a remote data source. For example, determination module 106 may, as part of first virtual storage appliance 202 in FIG. 2, determine that second virtual storage appliance 208 is responsible for caching requested data 122 from remote data source 210.

Determination module 106 may determine that second virtual storage appliance 208 is responsible for caching requested data 122 in a variety of ways. In some examples, determination module 106 may use a hashing algorithm that coordinates peer-to-peer caching among the first and second virtual storage appliances. The term “peer-to-peer caching,” as used herein, generally refers to methods of distributing data between peers by storing data from one peer in the cache of a second peer. Peer-to-peer caching may allow peer VSAs within the same cloud environment to share data. Additionally or alternatively, determination module 106 may identify a data fingerprint of the requested data. The term “data fingerprint,” as used herein, generally refers to a string that can be used to identify a data item, particularly as part of a hashing algorithm.

Furthermore, in one embodiment, the hashing algorithm may include a set of rules to distribute data for copy data management. Examples of hashing algorithms may include, without limitation, consistent hashing, rendezvous hashing, peer-to-peer distributed hashing, or any other suitable algorithm to distribute data among available resources. The terms “consistent hashing” and “rendezvous hashing,” as used herein, generally refer to hashing techniques that redistribute resources based on a dynamic number of available sites to store those resources. The term “peer-to-peer distributed hashing,” as used herein, generally refers to hashing methods that use a distributed hash table in order to share files and data in peer-to-peer systems. In some examples, the hashing algorithm may map various segments of a dataset within remote data source 210 based on usage by virtual machines. In other examples, the hashing algorithm may map the dataset based on a different metric, such as proximity of data. Additionally, the hashing algorithm may map data from multiple remote data sources. By using the hashing algorithm, the disclosed systems may efficiently distribute the dataset in remote data source 210 between multiple VSAs.

As noted, the hashing algorithms and/or other processes discussed herein may be implemented as part of a copy data management system. The term “copy data management” generally refers to methods of creating and maximizing efficient usage of data copies. Copy data management may involve eliminating unnecessary duplication of data and/or otherwise efficiently caching and storing data according to any embodiments discussed herein.

Returning to FIG. 3, at step 308, one or more of the systems described herein may transfer the requested data from the second virtual storage appliance to the first virtual storage appliance. For example, transfer module 110 may, as part of first virtual storage appliance 202 in FIG. 2, transfer requested data 122 from second virtual storage appliance 208 to first virtual storage appliance 202.

Transfer module 110 may transfer requested data 122 in a variety of ways. In some examples, transfer module 110 may locate requested data 122 in second virtual storage appliance 208. In one embodiment, locating requested data 122 in second virtual storage appliance 208 may include finding requested data 122 cached at second virtual storage appliance 208. For example, as shown in FIG. 4, requested data 122(1) may be cached in local data cache 406(2) within second virtual storage appliance 208 after virtual machine 216(1) requests dataset 408(3). Additionally or alternatively, locating requested data 122 may include copying requested data 122 from remote data source 210 to second virtual storage appliance 208 via network 204 and/or caching requested data 122 at second virtual storage appliance 208. In the example of FIG. 4, second virtual storage appliance 208 may copy and cache requested data 122(2) from remote data source 210 after virtual machine 216(2) requests a dataset 408(4). Furthermore, second virtual storage appliance 208 may need to locate requested data 122(2) among a multitude of remote data sources before caching at local data cache 406(2).

In other examples, transfer module 110 may transfer requested data 122 by caching at least part of requested data 122 at first virtual storage appliance 202. Additionally or alternatively, in some examples, transfer module 110 may remove requested data 122 from second virtual storage appliance 208. In these examples, transfer module 110 may determine, based on a cache algorithm, that caching requested data 122 at second virtual storage appliance 208 is more costly than caching requested data 122 at first virtual storage appliance 202. Additionally, transfer module 110 may remap a hash table based on the determination of the cache algorithm. In one embodiment, the cache algorithm may determine cost by analyzing the total latency of virtual machines accessing requested data 122 when cached at different VSAs. In another embodiment, the cache algorithm may determine cost by analyzing storage capacity of VSAs. The cache algorithm may also determine that requested data 122 may be cached in multiple VSAs for efficiency. Alternatively, combinations of the above and/or other suitable metrics may be used by the cache algorithm.

Returning to FIG. 3, at step 310, one or more of the systems described herein may provide the requested data from the first virtual storage appliance to the virtual machine. For example, provision module 112 may, as part of first virtual storage appliance 202 in FIG. 2, provide requested data 122 from first virtual storage appliance 202 to virtual machine 216.

Provision module 112 may provide requested data 122 in a variety of ways. In the example of FIG. 4, first virtual storage appliance 202 may cache requested data 122(1) at local data cache 406(1). In this example, virtual machine 216(1) and virtual machine 216(2) may access local data cache 406(1) on an as-needed basis. In an alternate example, first virtual storage appliance 202 may transmit all or a portion of local data cache 406(1) to virtual machine 216(1) and/or virtual machine 216(2) when requested.

As explained above in connection with method 300 in FIG. 3, the disclosed systems and methods may, by applying peer-to-peer caching to a copy data management system, provide an efficient method of distributing data among cloud-based virtual storage appliances. Specifically, by identifying groups of virtual machines that use much of the same data, particularly for use in application development and testing, the disclosed systems and methods may first assign one VSA to each group of virtual machines. The disclosed systems and methods may also assign a portion of a dataset running on a remote data source, such as a physical data appliance, to the VSA managing a data cache for a group of virtual machines. Each VSA within a cloud environment may thus be responsible for a different portion of the data running on the remote data source. For example, the systems and methods described herein may cache, at the VSA of a hypervisor, the common data used by a group of virtual machines running on the hypervisor. By doing so, the disclosed systems and methods may enable the VSA to only cache the data most used by the virtual machines, rather than copying the entire dataset from the remote data source.

The disclosed systems and methods may further allow VSAs to coordinate data caching and exchanges among themselves. In the above example, when a virtual machine requests a particular data item, the VSA in charge of the virtual machine may first check its own cache for the data item. If the VSA is responsible for the data item, it may retrieve it from the remote data source and cache it for future use. If the data item is not in the cache and the VSA is not responsible for caching the data item, the VSA may use a hashing algorithm to identify and obtain the data item from a second VSA within the cloud, rather than from the remote data source, or prompt the second VSA to obtain the data item from the remote data source and send it to the first VSA. Eventually, the VSAs within the same cloud environment may distribute all of the data on the remote data source among themselves to avoid network latency caused by retrieving data from the remote data source. By using copy data management to direct the peer-to-peer caching of data workloads, the systems and methods described herein may be able to efficiently use a minimal number of data copies. Additionally, by using a caching algorithm, the disclosed systems and methods may be able to analyze costs of different data distributions among VSAs. The most efficient method of distributing data may further reduce latency caused by sending data from one VSA to another.

As detailed above, by coordinating distribution of data caching between multiple VSAs, the disclosed systems and methods may reduce network bandwidth costs and latency in retrieving data that is commonly used by virtual machines. In addition, efficient distribution of data caching may also reduce storage costs by decreasing the amount of redundancy among VSAs. Thus, the systems and methods described herein may provide better coordination of virtual storage appliances than traditional methods.

FIG. 5 is a block diagram of an exemplary computing system 510 capable of implementing one or more of the embodiments described and/or illustrated herein. For example, all or a portion of computing system 510 may perform and/or be a means for performing, either alone or in combination with other elements, one or more of the steps described herein (such as one or more of the steps illustrated in FIG. 3). All or a portion of computing system 510 may also perform and/or be a means for performing any other steps, methods, or processes described and/or illustrated herein.

Computing system 510 broadly represents any single or multi-processor computing device or system capable of executing computer-readable instructions. Examples of computing system 510 include, without limitation, workstations, laptops, client-side terminals, servers, distributed computing systems, handheld devices, or any other computing system or device. In its most basic configuration, computing system 510 may include at least one processor 514 and a system memory 516.

Processor 514 generally represents any type or form of physical processing unit (e.g., a hardware-implemented central processing unit) capable of processing data or interpreting and executing instructions. In certain embodiments, processor 514 may receive instructions from a software application or module. These instructions may cause processor 514 to perform the functions of one or more of the exemplary embodiments described and/or illustrated herein.

System memory 516 generally represents any type or form of volatile or non-volatile storage device or medium capable of storing data and/or other computer-readable instructions. Examples of system memory 516 include, without limitation, Random Access Memory (RAM), Read Only Memory (ROM), flash memory, or any other suitable memory device. Although not required, in certain embodiments computing system 510 may include both a volatile memory unit (such as, for example, system memory 516) and a non-volatile storage device (such as, for example, primary storage device 532, as described in detail below). In one example, one or more of modules 102 from FIG. 1 may be loaded into system memory 516.

In certain embodiments, exemplary computing system 510 may also include one or more components or elements in addition to processor 514 and system memory 516. For example, as illustrated in FIG. 5, computing system 510 may include a memory controller 518, an Input/Output (I/O) controller 520, and a communication interface 522, each of which may be interconnected via a communication infrastructure 512. Communication infrastructure 512 generally represents any type or form of infrastructure capable of facilitating communication between one or more components of a computing device. Examples of communication infrastructure 512 include, without limitation, a communication bus (such as an Industry Standard Architecture (ISA), Peripheral Component Interconnect (PCI), PCI Express (PCIe), or similar bus) and a network.

Memory controller 518 generally represents any type or form of device capable of handling memory or data or controlling communication between one or more components of computing system 510. For example, in certain embodiments memory controller 518 may control communication between processor 514, system memory 516, and I/O controller 520 via communication infrastructure 512.

I/O controller 520 generally represents any type or form of module capable of coordinating and/or controlling the input and output functions of a computing device. For example, in certain embodiments I/O controller 520 may control or facilitate transfer of data between one or more elements of computing system 510, such as processor 514, system memory 516, communication interface 522, display adapter 526, input interface 530, and storage interface 534.

Communication interface 522 broadly represents any type or form of communication device or adapter capable of facilitating communication between exemplary computing system 510 and one or more additional devices. For example, in certain embodiments communication interface 522 may facilitate communication between computing system 510 and a private or public network including additional computing systems. Examples of communication interface 522 include, without limitation, a wired network interface (such as a network interface card), a wireless network interface (such as a wireless network interface card), a modem, and any other suitable interface. In at least one embodiment, communication interface 522 may provide a direct connection to a remote server via a direct link to a network, such as the Internet. Communication interface 522 may also indirectly provide such a connection through, for example, a local area network (such as an Ethernet network), a personal area network, a telephone or cable network, a cellular telephone connection, a satellite data connection, or any other suitable connection.

In certain embodiments, communication interface 522 may also represent a host adapter configured to facilitate communication between computing system 510 and one or more additional network or storage devices via an external bus or communications channel. Examples of host adapters include, without limitation, Small Computer System Interface (SCSI) host adapters, Universal Serial Bus (USB) host adapters, Institute of Electrical and Electronics Engineers (IEEE) 1394 host adapters, Advanced Technology Attachment (ATA), Parallel ATA (PATA), Serial ATA (SATA), and External SATA (eSATA) host adapters, Fibre Channel interface adapters, Ethernet adapters, or the like. Communication interface 522 may also allow computing system 510 to engage in distributed or remote computing. For example, communication interface 522 may receive instructions from a remote device or send instructions to a remote device for execution.

As illustrated in FIG. 5, computing system 510 may also include at least one display device 524 coupled to communication infrastructure 512 via a display adapter 526. Display device 524 generally represents any type or form of device capable of visually displaying information forwarded by display adapter 526. Similarly, display adapter 526 generally represents any type or form of device configured to forward graphics, text, and other data from communication infrastructure 512 (or from a frame buffer, as known in the art) for display on display device 524.

As illustrated in FIG. 5, exemplary computing system 510 may also include at least one input device 528 coupled to communication infrastructure 512 via an input interface 530. Input device 528 generally represents any type or form of input device capable of providing input, either computer or human generated, to exemplary computing system 510. Examples of input device 528 include, without limitation, a keyboard, a pointing device, a speech recognition device, or any other input device.

As illustrated in FIG. 5, exemplary computing system 510 may also include a primary storage device 532 and a backup storage device 533 coupled to communication infrastructure 512 via a storage interface 534. Storage devices 532 and 533 generally represent any type or form of storage device or medium capable of storing data and/or other computer-readable instructions. For example, storage devices 532 and 533 may be a magnetic disk drive (e.g., a so-called hard drive), a solid state drive, a floppy disk drive, a magnetic tape drive, an optical disk drive, a flash drive, or the like. Storage interface 534 generally represents any type or form of interface or device for transferring data between storage devices 532 and 533 and other components of computing system 510. In one example, database 120 from FIG. 1 may be stored in primary storage device 532.

In certain embodiments, storage devices 532 and 533 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Storage devices 532 and 533 may also include other similar structures or devices for allowing computer software, data, or other computer-readable instructions to be loaded into computing system 510. For example, storage devices 532 and 533 may be configured to read and write software, data, or other computer-readable information. Storage devices 532 and 533 may also be a part of computing system 510 or may be a separate device accessed through other interface systems.

Many other devices or subsystems may be connected to computing system 510. Conversely, all of the components and devices illustrated in FIG. 5 need not be present to practice the embodiments described and/or illustrated herein. The devices and subsystems referenced above may also be interconnected in different ways from that shown in FIG. 5. Computing system 510 may also employ any number of software, firmware, and/or hardware configurations. For example, one or more of the exemplary embodiments disclosed herein may be encoded as a computer program (also referred to as computer software, software applications, computer-readable instructions, or computer control logic) on a computer-readable medium. The phrase “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The computer-readable medium containing the computer program may be loaded into computing system 510. All or a portion of the computer program stored on the computer-readable medium may then be stored in system memory 516 and/or various portions of storage devices 532 and 533. When executed by processor 514, a computer program loaded into computing system 510 may cause processor 514 to perform and/or be a means for performing the functions of one or more of the exemplary embodiments described and/or illustrated herein. Additionally or alternatively, one or more of the exemplary embodiments described and/or illustrated herein may be implemented in firmware and/or hardware. For example, computing system 510 may be configured as an Application Specific Integrated Circuit (ASIC) adapted to implement one or more of the exemplary embodiments disclosed herein.

FIG. 6 is a block diagram of an exemplary network architecture 600 in which client systems 610, 620, and 630 and servers 640 and 645 may be coupled to a network 650. As detailed above, all or a portion of network architecture 600 may perform and/or be a means for performing, either alone or in combination with other elements, one or more of the steps disclosed herein (such as one or more of the steps illustrated in FIG. 3). All or a portion of network architecture 600 may also be used to perform and/or be a means for performing other steps and features set forth in the instant disclosure.

Client systems 610, 620, and 630 generally represent any type or form of computing device or system, such as exemplary computing system 510 in FIG. 5. Similarly, servers 640 and 645 generally represent computing devices or systems, such as application servers or database servers, configured to provide various database services and/or run certain software applications. Network 650 generally represents any telecommunication or computer network including, for example, an intranet, a WAN, a LAN, a PAN, or the Internet. In one example, client systems 610, 620, and/or 630 and/or servers 640 and/or 645 may include all or a portion of system 100 from FIG. 1.

As illustrated in FIG. 6, one or more storage devices 660(1)-(N) may be directly attached to server 640. Similarly, one or more storage devices 670(1)-(N) may be directly attached to server 645. Storage devices 660(1)-(N) and storage devices 670(1)-(N) generally represent any type or form of storage device or medium capable of storing data and/or other computer-readable instructions. In certain embodiments, storage devices 660(1)-(N) and storage devices 670(1)-(N) may represent Network-Attached Storage (NAS) devices configured to communicate with servers 640 and 645 using various protocols, such as Network File System (NFS), Server Message Block (SMB), or Common Internet File System (CIFS).

Servers 640 and 645 may also be connected to a Storage Area Network (SAN) fabric 680. SAN fabric 680 generally represents any type or form of computer network or architecture capable of facilitating communication between a plurality of storage devices. SAN fabric 680 may facilitate communication between servers 640 and 645 and a plurality of storage devices 690(1)-(N) and/or an intelligent storage array 695. SAN fabric 680 may also facilitate, via network 650 and servers 640 and 645, communication between client systems 610, 620, and 630 and storage devices 690(1)-(N) and/or intelligent storage array 695 in such a manner that devices 690(1)-(N) and array 695 appear as locally attached devices to client systems 610, 620, and 630. As with storage devices 660(1)-(N) and storage devices 670(1)-(N), storage devices 690(1)-(N) and intelligent storage array 695 generally represent any type or form of storage device or medium capable of storing data and/or other computer-readable instructions.

In certain embodiments, and with reference to exemplary computing system 510 of FIG. 5, a communication interface, such as communication interface 522 in FIG. 5, may be used to provide connectivity between each client system 610, 620, and 630 and network 650. Client systems 610, 620, and 630 may be able to access information on server 640 or 645 using, for example, a web browser or other client software. Such software may allow client systems 610, 620, and 630 to access data hosted by server 640, server 645, storage devices 660(1)-(N), storage devices 670(1)-(N), storage devices 690(1)-(N), or intelligent storage array 695. Although FIG. 6 depicts the use of a network (such as the Internet) for exchanging data, the embodiments described and/or illustrated herein are not limited to the Internet or any particular network-based environment.

In at least one embodiment, all or a portion of one or more of the exemplary embodiments disclosed herein may be encoded as a computer program and loaded onto and executed by server 640, server 645, storage devices 660(1)-(N), storage devices 670(1)-(N), storage devices 690(1)-(N), intelligent storage array 695, or any combination thereof. All or a portion of one or more of the exemplary embodiments disclosed herein may also be encoded as a computer program, stored in server 640, run by server 645, and distributed to client systems 610, 620, and 630 over network 650.

As detailed above, computing system 510 and/or one or more components of network architecture 600 may perform and/or be a means for performing, either alone or in combination with other elements, one or more steps of an exemplary method for coordinating data caching on virtual storage appliances.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

In some examples, all or a portion of exemplary system 100 in FIG. 1 may represent portions of a cloud-computing or network-based environment. Cloud-computing environments may provide various services and applications via the Internet. These cloud-based services (e.g., software as a service, platform as a service, infrastructure as a service, etc.) may be accessible through a web browser or other remote interface. Various functions described herein may be provided through a remote desktop environment or any other cloud-based computing environment.

In various embodiments, all or a portion of exemplary system 100 in FIG. 1 may facilitate multi-tenancy within a cloud-based computing environment. In other words, the software modules described herein may configure a computing system (e.g., a server) to facilitate multi-tenancy for one or more of the functions described herein. For example, one or more of the software modules described herein may program a server to enable two or more clients (e.g., customers) to share an application that is running on the server. A server programmed in this manner may share an application, operating system, processing system, and/or storage system among multiple customers (i.e., tenants). One or more of the modules described herein may also partition data and/or configuration information of a multi-tenant application for each customer such that one customer cannot access data and/or configuration information of another customer.

According to various embodiments, all or a portion of exemplary system 100 in FIG. 1 may be implemented within a virtual environment. For example, the modules and/or data described herein may reside and/or execute within a virtual machine. As used herein, the phrase “virtual machine” generally refers to any operating system environment that is abstracted from computing hardware by a virtual machine manager (e.g., a hypervisor). Additionally or alternatively, the modules and/or data described herein may reside and/or execute within a virtualization layer. As used herein, the phrase “virtualization layer” generally refers to any data layer and/or application layer that overlays and/or is abstracted from an operating system environment. A virtualization layer may be managed by a software virtualization solution (e.g., a file system filter) that presents the virtualization layer as though it were part of an underlying base operating system. For example, a software virtualization solution may redirect calls that are initially directed to locations within a base file system and/or registry to locations within a virtualization layer.

In some examples, all or a portion of exemplary system 100 in FIG. 1 may represent portions of a mobile computing environment. Mobile computing environments may be implemented by a wide range of mobile computing devices, including mobile phones, tablet computers, e-book readers, personal digital assistants, wearable computing devices (e.g., computing devices with a head-mounted display, smartwatches, etc.), and the like. In some examples, mobile computing environments may have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein may be provided for a mobile computing environment and/or may interact with a mobile computing environment.

In addition, all or a portion of exemplary system 100 in FIG. 1 may represent portions of, interact with, consume data produced by, and/or produce data consumed by one or more systems for information management. As used herein, the phrase “information management” may refer to the protection, organization, and/or storage of data. Examples of systems for information management may include, without limitation, storage systems, backup systems, archival systems, replication systems, high availability systems, data search systems, virtualization systems, and the like.

In some embodiments, all or a portion of exemplary system 100 in FIG. 1 may represent portions of, produce data protected by, and/or communicate with one or more systems for information security. As used herein, the phrase “information security” may refer to the control of access to protected data. Examples of systems for information security may include, without limitation, systems providing managed security services, data loss prevention systems, identity authentication systems, access control systems, encryption systems, policy compliance systems, intrusion detection and prevention systems, electronic discovery systems, and the like.

According to some examples, all or a portion of exemplary system 100 in FIG. 1 may represent portions of, communicate with, and/or receive protection from one or more systems for endpoint security. As used herein, the phrase “endpoint security” may refer to the protection of endpoint systems from unauthorized and/or illegitimate use, access, and/or control. Examples of systems for endpoint protection may include, without limitation, anti-malware systems, user authentication systems, encryption systems, privacy systems, spam-filtering services, and the like.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

While various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

In addition, one or more of the modules described herein may transform data, physical devices, and/or representations of physical devices from one form to another. For example, one or more of the modules recited herein may receive a request for data from a virtual machine to be transformed, transform the data request, output a result of the transformation to a storage or output device, use the result of the transformation to locate the requested data, and store the result of the transformation in a server or data cache. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method for coordinating data caching on virtual storage appliances, at least a portion of the method being performed by a computing device comprising at least one processor, the method comprising:
receiving, at a first virtual storage appliance, a request for data from a virtual machine in a first set of virtual machines served by the first virtual storage appliance;
determining that the requested data is not cached at the first virtual storage appliance;
determining that a second virtual storage appliance is responsible for caching the requested data from a remote data source;
transferring the requested data from the second virtual storage appliance to the first virtual storage appliance;
providing the requested data from the first virtual storage appliance to the virtual machine.

2. The method of claim 1, wherein the first virtual storage appliance comprises a cloud-based storage controller that manages a local data cache for a hypervisor running the first set of virtual machines in a cloud environment containing the second virtual storage appliance.

3. The method of claim 1, wherein the first set of virtual machines comprises a grouping of at least one virtual machine sharing a common dataset that differs, based on a predefined threshold, from a second dataset shared by a second set of virtual machines.

4. The method of claim 1, wherein determining that the second virtual storage appliance is responsible for caching the requested data comprises at least one of:
using a hashing algorithm that coordinates peer-to-peer caching among the first and second virtual storage appliances;
identifying a data fingerprint of the requested data.

5. The method of claim 4, wherein the hashing algorithm comprises a set of rules to distribute data for copy data management.

6. The method of claim 1, wherein transferring the requested data from the second virtual storage appliance to the first virtual storage appliance comprises at least one of:
locating the requested data in the second virtual storage appliance;
caching at least part of the requested data at the first virtual storage appliance;
removing the requested data from the second virtual storage appliance.

7. The method of claim 6, wherein locating the requested data in the second virtual storage appliance comprises at least one of:
finding the requested data cached at the second virtual storage appliance;
copying the requested data from the remote data source to the second virtual storage appliance;
caching the requested data at the second virtual storage appliance.

8. The method of claim 6, wherein removing the requested data from the second virtual storage appliance comprises at least one of:
determining, based on a cache algorithm, that caching the requested data at the second virtual storage appliance is more costly than caching the requested data at the first virtual storage appliance;
remapping a hash table based on the determination.

9. A system for coordinating data caching on virtual storage appliances, the system comprising:
a reception module, stored in memory, that receives, at a first virtual storage appliance, a request for data from a virtual machine in a first set of virtual machines served by the first virtual storage appliance;
a determination module, stored in memory, that determines that the requested data is not cached at the first virtual storage appliance;
a coordination module, stored in memory, that determines that a second virtual storage appliance is responsible for caching the requested data from a remote data source;
a transfer module, stored in memory, that transfers the requested data from the second virtual storage appliance to the first virtual storage appliance;
a provision module, stored in memory, that provides the requested data from the first virtual storage appliance to the virtual machine;
at least one processor that executes the reception module, the determination module, the coordination module, the transfer module, and the provision module.

10. The system of claim 9, wherein the first virtual storage appliance comprises a cloud-based storage controller that manages a local data cache for a hypervisor running the first set of virtual machines in a cloud environment containing the second virtual storage appliance.

11. The system of claim 9, wherein the first set of virtual machines comprises a grouping of at least one virtual machine sharing a common dataset that differs, based on a predefined threshold, from a second dataset shared by a second set of virtual machines.

12. The system of claim 9, wherein the coordination module determines that the second virtual storage appliance is responsible for caching the requested data by at least one of:
using a hashing algorithm that coordinates peer-to-peer caching among the first and second virtual storage appliances;
identifying a data fingerprint of the requested data.

13. The system of claim 12, wherein the hashing algorithm comprises a set of rules to distribute data for copy data management.

14. The system of claim 9, wherein the transfer module transfers the requested data from the second virtual storage appliance to the first virtual storage appliance by at least one of:
locating the requested data in the second virtual storage appliance;
caching at least part of the requested data at the first virtual storage appliance;
removing the requested data from the second virtual storage appliance.

15. The system of claim 14, wherein locating the requested data in the second virtual storage appliance comprises at least one of:
finding the requested data cached at the second virtual storage appliance;
copying the requested data from the remote data source to the second virtual storage appliance;
caching the requested data at the second virtual storage appliance.

16. The system of claim 14, wherein removing the requested data from the second virtual storage appliance comprises at least one of:
determining, based on a cache algorithm, that caching the requested data at the second virtual storage appliance is more costly than caching the requested data at the first virtual storage appliance;
remapping a hash table based on the determination.

17. A non-transitory computer-readable medium comprising one or more computer-executable instructions that, when executed by at least one processor of a computing device, cause the computing device to:
receive, at a first virtual storage appliance, a request for data from a virtual machine in a first set of virtual machines served by the first virtual storage appliance;
determine that the requested data is not cached at the first virtual storage appliance;
determine that a second virtual storage appliance is responsible for caching the requested data from a remote data source;
transfer the requested data from the second virtual storage appliance to the first virtual storage appliance;
provide the requested data from the first virtual storage appliance to the virtual machine.

18. The non-transitory computer-readable medium of claim 17, wherein the first virtual storage appliance comprises a cloud-based storage controller that manages a local data cache for a hypervisor running the first set of virtual machines in a cloud environment containing the second virtual storage appliance.

19. The non-transitory computer-readable medium of claim 17, wherein the first set of virtual machines comprises a grouping of at least one virtual machine sharing a common dataset that differs, based on a predefined threshold, from a second dataset shared by a second set of virtual machines.

20. The non-transitory computer-readable medium of claim 17, wherein the computer-executable instructions cause the computing device to determine that the second virtual storage appliance is responsible for caching the requested data by at least one of:
using a hashing algorithm that coordinates peer-to-peer caching among the first and second virtual storage appliances;
identifying a data fingerprint of the requested data.
